(19) United States
(12) Patent Application Publication
(10) Pub. No.: US 2016/0098026 A1
(43) Pub. Date: Apr. 7, 2016

(54) TEMPERATURE CONTROL SYSTEM AND METHODS OF PERFORMING THE SAME

(71) Applicants: Mohamed Farouk SALEM, Fresno, CA (US); Michael Robert Sullivan, Manchester (GB)

(72) Inventors: Mohamed Farouk SALEM, Fresno, CA (US); Michael Robert Sullivan, Manchester (GB)

(21) Appl. No.: 14/872,675

(22) Filed: Oct. 1, 2015

Related U.S. Application Data
(60) Provisional application No. 62/058,744, filed on Oct. 2, 2014.

(51) Int. Cl. G05B 19/042; G05D 23/13

(52) U.S. Cl. CPC G05B 19/042; G05D 23/1393; G05B 2219/2614

(57) ABSTRACT

A temperature control system for controlling the environmental conditions in a space, the system including a temperature control unit having a memory and a processor with a program operating in the memory executing the steps of gathering indoor environmental information by the temperature control unit, gathering outdoor environmental information via a network communicatively coupled to the temperature control unit, determining a floating set point based on the indoor and outdoor conditions, determining an operational mode of the system, and controlling temperature control equipment to maintain the floating set point.

### RELATED APPLICATIONS

This application claims the benefit of and the priority from U.S. provisional Application No. 62/058,744 filed Oct. 2, 2014 entitled TEMPERATURE CONTROL SYSTEM AND METHODS OF PERFORMING THE SAME, which is incorporated in its entirety herein by reference.

### DETAILED DESCRIPTION OF THE INVENTION

Human comfort is a goal the HVAC industry strives to achieve. However, comfort can be very costly as energy prices continuously rise. Generally, heating and cooling represents a minimum of 50% of a building's energy consumption.

Human comfort is based on many factors, such as the surrounding air temperature Dry Bulb (DB), Relative Humidity (RH), wind speed (WS) and elevation. Current temperature controllers only use one dimension air temperature Dry Bulb DB, assuming at low temperatures range all other factors could be ignored. Regulating indoor temperature based only on single set point does not maximize energy savings in the summertime, and may lead to an uncomfortable temperature in the wintertime.

Therefore, a need exists for a system that will maximize energy savings while also providing comfort to people residing in a space.

### SUMMARY OF THE INVENTION

One embodiment of the present disclosure may include a temperature control system for controlling the environmental conditions in a space, the system including a temperature control unit having a memory and a processor with a program operating in the memory executing the steps of gathering indoor environmental information by the temperature control unit, gathering outdoor environmental information via a network communicatively coupled to the temperature control unit, determining a floating set point based on the indoor and outdoor conditions, determining an operational mode of the system, and controlling temperature control equipment to maintain the floating set point.

In another embodiment, the temperature control unit gathers indoor temperature information from a temperature sensor in the space.

In another embodiment, the temperature control unit determines the operational mode of the system based on information gathered from an occupancy sensor.

In another embodiment, the location of the temperature control unit is determined using a GPS unit.

In another embodiment, the location includes the altitude of the temperature control unit.

In another embodiment, information on the altitude of the temperature control unit is gathered from an altimeter in the temperature control unit.

In another embodiment, the outdoor environmental information is gathered based on the location of the temperature control unit.

In another embodiment, the outdoor environmental information is gathered based on the location and altitude of the temperature control unit.

In another embodiment, the altitude of the temperature control unit is determined based on the location of the temperature control unit.

In another embodiment, the indoor environmental information includes humidity information gathered from a humidity sensor coupled to the temperature control unit.

Another embodiment of the present disclosure includes a temperature control unit including a processor, a memory, an input/output unit, at least one indoor environmental monitoring unit coupled to the input/output unit, a network connection unit connected to a network and an outdoor environmental unit coupled to the network connection unit to gather information on outdoor environmental conditions via the network where a floating set point is determined based on information from the indoor environmental unit and the outdoor environmental unit.

In another embodiment, the indoor environmental unit includes a temperature sensor.

In another embodiment, the indoor environmental unit includes a humidity sensor.

In another embodiment, the temperature control unit may include an altitude detection unit.

In another embodiment, at least one mechanical device is controlled based on the floating set point.

In another embodiment, the altitude detection unit is an altimeter.

In another embodiment, the outdoor environmental information is gathered based on the location and altitude of the temperature control unit.

In another embodiment, the temperature control unit may include a location detection unit coupled to the input/output unit.

In another embodiment, the location detection unit is a GPS unit.

In another embodiment, the outdoor environmental information is determined based on the location of the temperature control unit.

### BRIEF DESCRIPTION OF THE DRAWINGS

Details of the present invention, including non-limiting benefits and advantages, will become more readily apparent to those of ordinary skill in the relevant art after reviewing the following detailed description and accompanying drawings, wherein:

FIG. 1 depicts a block diagram of a temperature control system suitable for use with the methods and systems consistent with the present invention;

FIG. 2 shows a more detailed depiction of the temperature control unit (TCU) of FIG. 1;

FIG. 3 depicts a schematic representation of the TCU controlling the environment of a space; and

FIG. 4 depicts a schematic representation of the TCU adjusting the floating set point.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

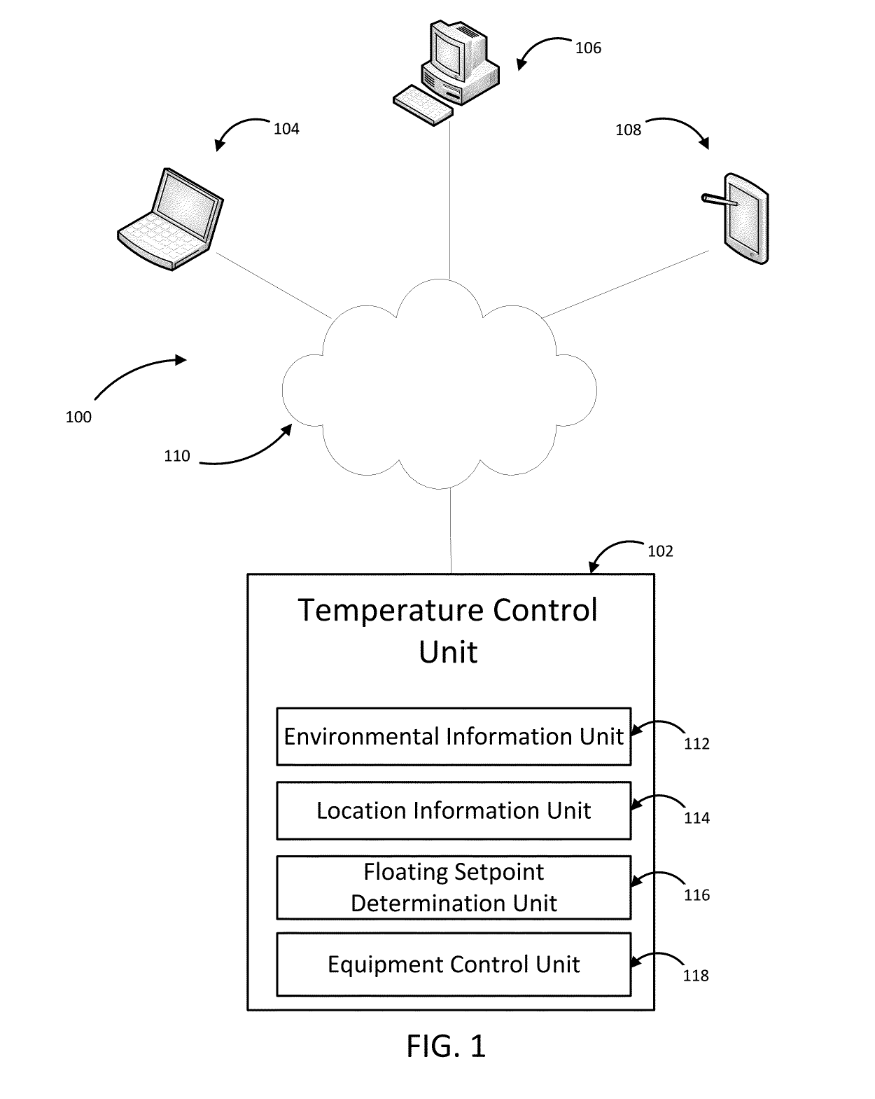

FIG. 1 depicts a block diagram of an Temperature Control System (“TCS”) 100 suitable for use with the methods and systems consistent with the present invention. The TCS 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a Temperature Control Unit (“TCU”) that includes an environmental information unit 112, a location information unit 114, a floating set point determination unit 116, and an equipment control unit 118. The number of computers and the network configuration shown in FIG. 1 are merely an illustrative example. One having skill in the art will appreciate that the SAS 100 may include a different number of computers and networks. For example, computer 102 may include the environmental information unit 112 as well as one or more of the location information unit 114. Further, the floating set point determination unit 116 and equipment control unit 118 may reside on a different computer than computer 102.

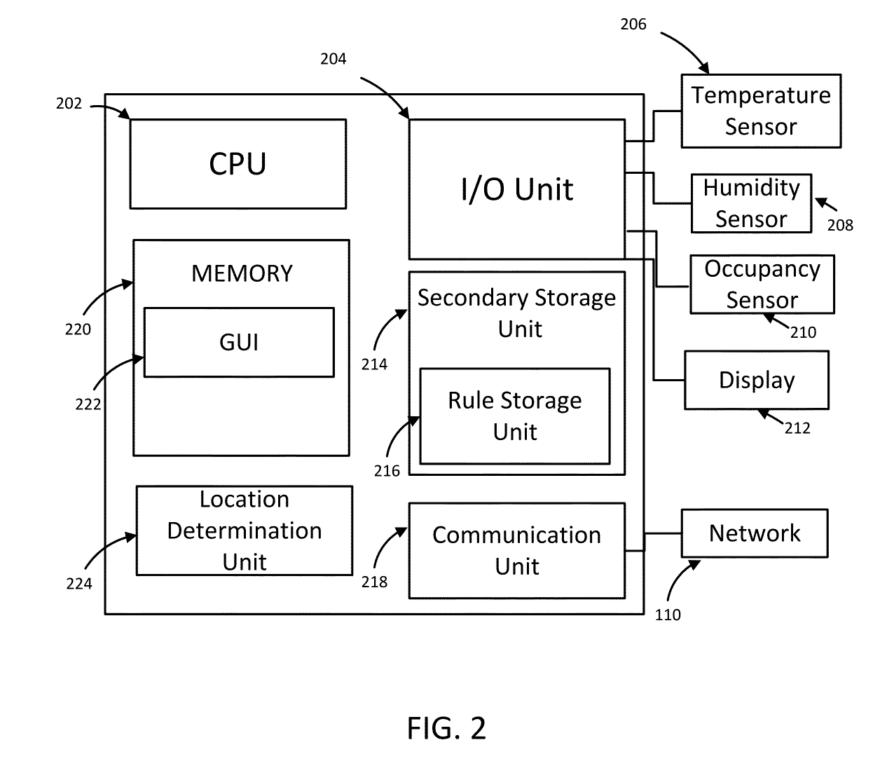

FIG. 2 shows a more detailed depiction of the temperature control unit 102. The temperature control unit 102 comprises a central processing unit (CPU) 202, an input output (IO) unit 204, a temperature sensor 206 and a humidity sensor 208, an occupancy sensor 210 and a display 212 each communicatively coupled to the IO Unit 204, a secondary storage device 214 that may include a rule storage unit 216, a communication unit 218 communicatively coupled to a network 110, a memory 220 and a location determination unit 224. The computer 202 may further comprise standard input devices such as a keyboard, a mouse, a digitizer, or a speech processing means (each not illustrated).

The computer 102's memory 220 includes a Graphical User Interface (“GUI”) 222 that is used to gather information from a user via the display device 206 and I/O unit 204 as described herein. The GUI 222 includes any user interface capable of being displayed on a display device 224 including, but not limited to, a web page, a display panel in an executable program, or any other interface capable of being displayed on a computer screen. The GUI 222 may also be stored in the secondary storage unit 214. In one embodiment consistent with the present invention, the GUI 222 is displayed using commercially available hypertext markup language (“HTML”) viewing software such as, but not limited to, Microsoft Internet Explorer, Google Chrome or any other commercially available HTML viewing software. The rule storage unit 216 may be a rational database such as, but not including Microsoft's SQL, Oracle or any other database.

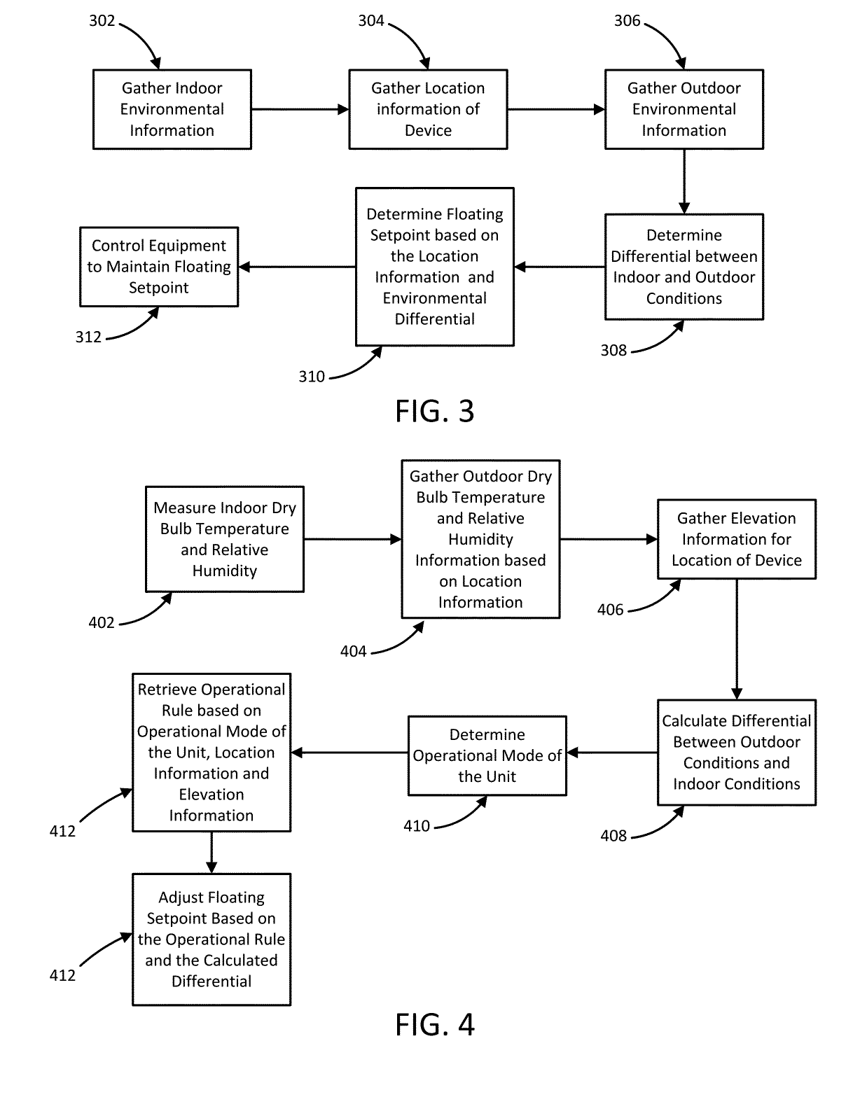

FIG. 3 depicts a schematic representation of the TCU 100 controlling the environment of a space In step 302, the environmental information unit 112 gathers information on the environment via the temperature sensor 206, humidity sensor 208 and occupancy sensor 210. The temperature sensor 206 may be any temperature sensor including, but not limited to, a thermistor, thermocouple, infrared sensor or any other type of temperature sensor. The humidity sensor 208 may be any known humidity sensor capable of measuring the relative humidity. The occupancy sensor 210 may be any known type of occupancy sensor including, but not limited to, an ultrasonic sensor, passive infrared sensor or any other type of occupancy sensor.

In step 304, the location of the TCU 100 is determined using the location determination unit 220. The location determination unit 220 is configured to determine the location of the TCU 100 including the global position and altitude of the TCU 100. The location determination unit 220 may be a global positioning system (“GPS”). The location determination unit 220 may include an altimeter to determine the altitude of the SAU 100. The location determination unit 114 may also determine the location of the TCU 100 via the network connection 110. In step 306, the location information unit 114 gathers outdoor information for the identified location via the network 110. The outdoor information may include, but is not limited to, the outdoor temperature, outdoor humidity, atmospheric pressure, elevation, wind direction and speed, and any other outdoor environmental information. In another embodiment, the location information unit 114 gathers information on the predicted future environmental conditions via the network 110.

In step 308, the floating set point determination unit 116 determines a differential value between the indoor conditions and the outdoor conditions. As an illustrative example, the floating set point determination unit 116 may determine the differential between the indoor temperature and outdoor temperature. The floating set point determination unit 116 may also calculate different values using the gathered indoor and outdoor information including calculating indoor and outdoor enthalpy.

In step 310, the floating set point determination unit 116 determines a floating set point value based on the location information and the differential between the indoor and outdoor environmental conditions. The floating set point determination unit 116 may generate the floating set point value by performing a psychometric analyzing the of the indoor and outdoor environmental conditions based on the location information. The floating set point represents a value used to control equipment to maintain a desired comfort level in a space. The floating set point may be between a predetermined range with the predetermined range being determined based on the indoor and outdoor conditions. The floating set point may be reset to a value in the predetermined range and the predetermined range may fluctuate based on the indoor and outdoor conditions.

In step 312, the equipment control unit 118 controls fans and heating and cooling equipment to maintain the floating set point. Maintaining the floating set point may cause the equipment controlling the environmental equipment in the space to operate for longer or shorter durations than they would operate when controlling to a comfort level set point only. Further, the floating set point and floating set point range may be adjusted based on the perceived occupancy gathered by the occupancy sensor. Because the floating set point is dynamically changing in relation to indoor and outdoor conditions, better comfort control can be achieved.

FIG. 4 depicts a schematic representation of the TCU 100 adjusting the floating set point. In step 402, the environmental information unit 112 measures the dry bulb temperature and relative humidity of the indoor space via the temperature sensor 206 and humidity sensor 208. In step 404, the environmental information unit 112 gathers outdoor temperature and humidity information from the network 110. As an illustrative example, the environmental information unit 112 may contact a web site or database storing real time outdoor environmental information for the location where the TCU 100 resides. The information may be stored in the memory 220 of the TCU 100.

In step 406, the location information unit 114 gathers elevation information on the location where the TCU 100 resides. The elevation information may be gathered by an instrument, such as an altimeter, in the TCU 100 or via the network. In step 408, the floating set point determination unit 116 calculates the difference between the outdoor conditions and the indoor conditions. In step 410, the TCU 100 determines the operation mode of the environmental units controlling the space. The operational mode may be a heating mode where a heat source is used to increase temperature in the space or a cooling mode, where a heat removal device is used to reduce the amount of heat in a space. In step 412, the TCU 100 retrieves an operational rule from the rule storage unit 216. The operational rule may be a predetermined range for the floating set point that is based on the environmental and location information. The operational rule may include specific instructions on how the floating set point or floating set point range should be adjusted based on the gathered information. As an illustrative example, if the outside air enthalpy is greater than the indoor enthalpy, an operational rule may raise the floating set point to a value higher than the inputted set point to remove more humidity from the space in a cooling mode, thereby improving comfort.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A temperature control system for controlling the environmental conditions in a space, the system including a temperature control unit having a memory and a processor with a program operating in the memory executing the steps of:
gathering indoor environmental information by the temperature control unit;
gathering outdoor environmental information via a network communicatively coupled to the temperature control unit;
determining a floating set point based on the indoor and outdoor conditions;
determining an operational mode of the system; and
controlling temperature control equipment to maintain the floating set point.

2. The temperature control system of claim 1, wherein the temperature control unit gathers indoor temperature information from a temperature sensor in the space.

3. The temperature control system of claim 1, wherein the temperature control unit determines the operational mode of the system based on information gathered from an occupancy sensor.

4. The temperature control system of claim 1, wherein the location of the temperature control unit is determined using a GPS unit.

5. The temperature control system of claim 4, wherein the location includes the altitude of the temperature control unit.

6. The temperature control system of claim 5, wherein information on the altitude of the temperature control unit is gathered from an altimeter in the temperature control unit.

7. The temperature control system of claim 5, wherein the outdoor environmental information is gathered based on the location of the temperature control unit.

8. The temperature control system of claim 6, wherein the outdoor environmental information is gathered based on the location and altitude of the temperature control unit.

9. The temperature control system of claim 5, wherein the altitude of the temperature control unit is determined based on the location of the temperature control unit.

10. The temperature control system of claim 1, wherein the indoor environmental information includes humidity information gathered from a humidity sensor coupled to the temperature control unit.

11. A temperature control unit including:
a processor;
a memory;
an input/output unit;
at least one indoor environmental monitoring unit coupled to the input/output unit;
a network connection unit connected to a network; and
an outdoor environmental unit coupled to the network connection unit to gather information on outdoor environmental conditions via the network,
wherein,
a floating set point is determined based on information from the indoor environmental unit and the outdoor environmental unit.

12. The temperature control unit of claim 11, wherein the indoor environmental unit includes a temperature sensor.

13. The temperature control unit of claim 11, wherein the indoor environmental unit includes a humidity sensor.

14. The temperature control unit of claim 11 including an altitude detection unit.

15. The temperature control unit of claim 11 wherein at least one mechanical device is controlled based on the floating set point.

16. The temperature control unit of claim 14, wherein the altitude detection unit is an altimeter.

17. The temperature control unit of claim 14, wherein the outdoor environmental information is gathered based on the location and altitude of the temperature control unit.

18. The temperature control system of claim 11, including a location detection unit coupled to the input/output unit.

19. The temperature control system of claim 18, wherein the location detection unit is a GPS unit.

20. The temperature control system of claim 18, wherein the outdoor environmental information is determined based on the location of the temperature control unit.
